(19) United States
(12) Patent Application Publication
(10) Pub. No.: US 2023/0313092 A1
(43) Pub. Date: Oct. 5, 2023

(54) SYSTEM AND METHOD FOR AGEING AQUEOUS SPIRITS IN RAILCARS BY PERIODIC TRANSIT VIA LOCOMOTION

(71) Applicant: PEYTON WILSON, PADUCAH, KY (US)

(72) Inventor: PEYTON WILSON, PADUCAH, KY (US)

(21) Appl. No.: 18/126,673

(22) Filed: Mar. 27, 2023

Related U.S. Application Data
(60) Provisional application No. 63/372,827, filed on Apr. 1, 2022.

(51) Int. Cl. C12G 3/08

(52) U.S. Cl. CPC C12G 3/08

(57) ABSTRACT

A system and method for ageing aqueous spirits in railcars by periodic locomotion is provided. The system includes a railcar positioned on railroad tracks; a plurality of storage racks positioned in an interior area of the railcar; a plurality of barrels, each containing aqueous spirits, removably positioned on the storage racks; and means for moving the railcar on the railroad tracks thereby agitating the aqueous spirits in the barrel to maximize the spirits flavor profiles. The method includes the steps of: positioning a railcar having a plurality of storage racks in an interior thereof on railroad tracks; positioning a plurality of barrels containing aqueous spirits on the storage racks; ageing the aqueous spirits in the plurality of barrels for a period of time; and removing the barrels of aged aqueous spirits from the storage racks and from the interior area of the railcar.

### BACKGROUND OF THE INVENTION

### Field of the Invention

The present invention relates to a system and method for aging aqueous spirits. More specifically, the present invention relates to an ageing method, which utilizes rail cars to store ageing spirits, that are then subjected to periodic locomotion, for the purpose of advantaging food products, with emphasis on certain flavor indicated characteristics within the contents of those methodically advantaged food products with unique combinations of patterned topographic experiences of a useful pattern or route upon the railroad, otherwise unavailable in the state of the art.

### Description of the Related Art

Distilled unaged spirits are generally colorless and without a mature flavor profile before enduring the ageing process, whereby spirits such as bourbon, whiskey, rum, scotch, sherry and brandy evolve into a more mature food product. The food product process of maturation in drinkable spirits is achieved by storing a liquid, such as unaged whiskey, commonly referred to as “white dog”, into containers with the ability to impart flavor indicative characteristics, most generally wooden barrels, which are lumber and metal products of cooperages, which for example, may be charred in the interior, so as to imprint flavor profiles of the charred wood upon the food product during the maturation process. Coloration and component flavors for each spirit are derivative and otherwise contingent upon the duration of exposure, and internal dynamics of the respective wooden barrels whether charred or uncharred. Effectively, the ageing method for spirits stored in these barrels take on their unique flavor as a result of the maturation dynamics of the time in contact with the internal wooden surface of the spirits container, such as a barrel, thereby resulting in the indispensable and unique flavor profiles of these food products which increase marketability.

At present, several disadvantages exist in the conventional ageing processes for spirits. By example, inventory costs associated with facilitation of warehousing throughout ageing processes are significant. As the inventory matures within the barrels, maintenance of humidity and temperature controls are paramount as potential hazards may exacerbate the costs of warehousing ageing spirits, such as fungal development in Baudoinia Compniacensis, within geographically disadvantageous areas or regions. Evaporation rates of the contents of the food product over the course of a desired ageing period likewise indicate clear and present disadvantages of the storage conditions of spirits throughout ageing processes because conventional warehousing, or rickhousing of food products do not produce consistent experiential variation.

Particular inefficiencies arise in the existing state-of-the-art methods of ageing spirits. Existent rickhouse design and warehousing facilities possess apparent disadvantages because of the duration of maturation within the available storage facilities and limitations of air flow exposure and topographical availability. Further, attempts to reconfigure the sorts of lumber, and structure used in barrels, variation of char within the barrels, and the refining procedures so as to include alternative wood sources have been explored in attempts to affect the time needed for maturing the spirits contained therein to a marketable condition.

Furthermore, present disadvantages of static state ageing methods exist as those methods because variant controls such as pressurization or depressurization and topographic humidity and temperature variations. Whereas advantages described herein foreseeably contribute potential advantages to flavor characteristic variables, likely further exhibiting the potential to optimize absorption and dissolution rates of the food product contents from the internal walls of the ageing container, as compared to food product positioned within a conventional rickhouse,.

Conventional rickhouse construction seeks to advantage topographic efficiencies of real estate features such as thermoregulation. However, in conventional ageing methods, save for occassional visual inspections, agitation remains markedly nonexistent at the potential of the method herein described. Over the duration of the maturation processes within conventional “rickhouses”, flavor profiling is de facto “static state” exposure of the liquid food product to the inside wall of the barrel. Purposefully, the ageing process and state of the art can be described as planned efforts to disperse sugar content and desired coloration effects upon the flavor profile so as to imprint the flavor characteristics in spirits.

Hypothetically, a particular spirit aged in one place for the duration of the ageing process, such as Bourbon X sitting in a warehouse in a specific place, such as Paducah, Kentucky for an ageing term - the duration of ageing the spirit before it is repackaged, in a container that is not actively ageing the spirit, or impressing flavor indicative experiences upon the food product - the ageing process would most assuredly be at a disadvantage when comparing the rate of an ageing process trait, such as the evaporation rate, when a similar spirit, say Bourbon Y, may advantage the ageing process trait under this method of ageing by charting a move of the food product within the rail car, subject to locomotion over a route pattern, to a more mild climate during the spring, so that in the summer months the food produce evaporation rate is optimally mitigated. Further, evaporation rates may contribute to higher yields of marketable food products at the end of an analogous static state ageing term. The same hypothetical can be positioned upon other ageing process trait advantages, such as a humidity, which a route move to a less humid environment may reduce the likelihood of mycilieal fragmentation, as fungal development presents a clear and present disadvantage with existing ageing methods.

Due to the potential to improve upon the methodology of conventional spirit ageing and their respective disadvantages in storage, product loss, maintenance and warehousing costs, exploration of alternative methods of ageing have incurred significant efforts to foster improvements. Efforts to increase the flavor profile, include by example the Solera, which is an ageing and blending method that seeks to marry older aged spirits with younger spirits, as evidently utilized in sherry wines, whiskeys, brandies and American bourbons as to accentuate more mature flavor profiles within blended spirits as indicated by flavor components such as tannin chain structure with emphasis on features such as monomeric anthocyanins, which are commonly recognized as marketable flavor indicative features of food products which contribute to desired coloration and flavor facets of marketable food products such as juices, wines, and other beverages. It is believed that by comparison this method could incorporate Soleras, by contrast for example Solera A (static ageing) would to a lesser degree exhibit its relative potential for flavor indicative characteristics such as variances in tannin structure in marketable food products (MFP). Whereas, it is believed that Solera B, subject of the contrived method disclosed herein, to a greater degree exhibits more relative potential for flavor indicative characteristics such as variances in tannin structure for MFP. When assuming Solera B enjoys the method of ageing spirits as contrived herein, the improvement on the upon the potential flavor profile output of MFP, particularly as the ageing process progresses, subject food product would have the advantage of agitation during locomotion powered movements, which is believed to manipulate congeners such as tannin chains and generate novel food products.

Accordingly, there is a need for a system and method for ageing spirits that produces a more consistent food product that possesses experiential advantages to the state of the art. More specifically, there is a need for a system and method that provides unique advantages over existing ageing methods by increased exposure of the food product to (1) temperature variation, (2) air flow, (3) elevation pattern variations which includes pressurization and depressurization, (4) agitation by reverberation, (5) topographical variations and (6) seasonal variations. The method herein describe patentably fulfills that purported need by contriving a novel method for placing ageing food products within a railcar, or series of railcars, selecting a route pattern based upon desired food product experience, moving the food product throughout the desired ageing process route pattern advantaging temperature, air flow, elevation, agitation, topographical and seasonal variations to improve upon the field of food products.

### SUMMARY OF THE INVENTION

It is therefore an object of the present invention to provide a unique method in development of flavor profiles in aqueous spirits during the ageing process of such food products by utilizing railcars subject to transit by locomotion to manipulate flavor indicative features to create novel flavor profiles therewithin. An ancillary object of this invention is to provide a consistent processes, unique to the method because of the newfound, and novel approach to ageing spirits that includes advantageous features of ageing such as agitation and air flow exposure during rail transit, thereby constituting the potential for improvement upon present standards for quality control and more consistent output of mature aqueous spirits that are marketable, i.e. patterned route could include focus on reduction of the evaporation rate of the food product during the ageing process by advantaging specific locations and movements, during specific times of the year. For example, moving a rail car to a colder climate during the summer months may reduce evaporation improving the yield of the food product.

It is also an object of the invention to provide a safe, effective and consistent means to expose conventional spirits flavor profiles to a greater degree of temperature, air flow, seasonal variation, and agitation and other flavor relevant variables during the ageing process by purposefully and periodically transporting barreled spirits upon railcars that are a part of freight trains, to travel throughout a railway network, advantaging topography to further the quality of food product contained therewithin.

The present invention meets these objects by providing a system and method for ageing of distilled spirits and increase the flavor profiling efficacy among those spirits by utilizing rail transit during the ageing process, thereby providing the spirits ageing process a more consistent food product that has the advantages over the state of the art. More specifically, the method provides unique advantages over existing ageing methods by increased exposure of the ageing spirits (1) to temperature variation, (2) air flow, (3) elevation which includes pressurization and depressurization, and (4) agitation by reverberation of the railcar when towed or pushed along a railway, or otherwise subjected to locomotion, (5) topographical and (6) seasonal variations.

Preceding any use of locomotion, this method requires the food product, generally an aqueous spirit to become barreled or otherwise contained in a permeable flavor profiling container, so that when the liquid is left to age within the barrels, for a duration of time as desired, so as to yield marketable food products, that distinguishably indicate variants of desired characteristics within those food products, with emphasis on flavor indicative components of the food products, such as tannin chains and more specifically monomeric anthocyanin structures. In practical example; because of the apparent advantages for food products, such as American bourbon whiskey, to age in differing places throughout the ageing process, a concrete and tangible differentiation exists, between the state of the art and the contrived method herein described, such that flavor indicative components like tannin chain structures will generate novel flavor profiles in the spirits subjected to this method when placed in railcars capable of transit and more specifically when pulled or pushed along a railroad by a locomotive throughout the rail network system as desired and shipped over a route pattern.

One presently preferred method of practice for the invention requires barreled spirits capable of ageing to be affixed within, or otherwise loaded into a railcar, that has been specified for the purposes of rail transit of said contents of food product from place to place, as a transit route or routes are patterned as desired, by an entity capable of overseeing the ageing process which may require legally recognizable credentials, such as a “liquor license”, having prepaid taxes and duties, less any non-applicable food product, such as vinegars, as reported to any appropriate regulatory agency. The scope of market implications and potential for new regulation is substantive, uncertain, and supports patentability.

The method contrived herein as applied to any ageing aqueous spirit seeks to adaptively manipulate flavor indicted components of food products like the congener features - minor compounds other than ethanol that occur naturally in alcohol beverages as a result of the distillation and fermentation process, such as tannins or tannin chains - to better express, articulate and accentuate desirable features within the field of food products, more specifically contained or barreled aged spirits.

Locomotion, and food product experiences within rail cars, exhibits the potential to desirably alter flavor indicated components such as tannin structures; with emphasis on monomeric anthocyanins and other flavor indicative characteristics because of the potential to expose the ageing process to newfound experiences only existent in railroad movement, such as, contrived under this method, agitation and pressurization and/or depressurization during specific temperature and topographical variations.

According to another presently preferred embodiment of the invention, there is provided a system for ageing aqueous spirits comprising: a railcar positioned on railroad tracks; a plurality of storage racks positioned in an interior area of the railcar; a plurality of barrels removably positioned on those storage racks, each of said plurality of barrels containing aqueous spirits; and locomotion power for moving said railcar on such patterned railroad tracks, agitating the aqueous spirits in the barrel to optimize the spirits and improve flavor profiles of the food products therein. The plurality of barrels may be wooden barrels. The system may further include a set of instruments may be positioned upon and within the railcar for collecting data during the ageing period. Means for correlating a dataset of information collected by said set of instruments with the plurality of barrels may also be provided, wherein the dataset comprises a set of temperature, humidity, airflow, elevation, pressurization or depressurization and vibration measurements.

The system may further include a set of climate control devices to achieve a desired temperature, humidity, aeration, and agitation levels based upon the dataset produced by the set of instruments within the interior storage area. The set of devices may comprise a humidifier and a plurality of exhaust vents, wherein said exhaust vents can mitigate prescreened hazardous conditions within the railcar with respect for the plurality of barrels. The system may further include ventilation slots located in sidewalls of the railcar, said ventilation slots being capable of adjustment or operation. The system may further include a set of spacers for separating the plurality of barrels from one another. The means for moving the railcar may include means for selectively and repeatably moving the railcar as desired and necessary to maximize the spirits flavor profiles with regard for temperature, humidity, elevation, aeration. The means for moving may comprise a locomotive engine connected to said railcar. A plurality of railcars, each containing a plurality of racks and a plurality of barrels, may be connected in a line to said locomotive engine to collectively comprise a unit train.

According to another presently preferred embodiment of the invention, there is provided a method for ageing aqueous spirits comprising the steps of: positioning a railcar on railroad tracks, said railcar having a plurality of storage racks positioned in an interior area thereof; positioning a plurality of barrels containing aqueous spirits on said storage racks; ageing the aqueous spirits in the plurality of barrels for a period of time; and removing the barrels of aged aqueous spirits from the storage racks and from the interior area of the railcar. The method may further comprise the step of periodically moving said railcar on said railroad tracks during said ageing process thereby agitating the aqueous spirits in the barrel to maximize the spirits flavor profiles with regard for temperature, humidity, elevation and aeration.

The method may further comprising the steps of: collecting from a set of instruments positioned upon and within the railcar during the ageing period; and correlating a dataset of information collected by said set of instruments with the plurality of barrels, wherein the dataset comprises a set of temperature, humidity, airflow, elevation, pressurization or depressurization and vibration measurements. The method may further include the step of operating a set of climate control devices to achieve a desired temperature, humidity, aeration, and agitation levels based upon the dataset produced by the set of instruments within the interior storage area. The set of devices may comprise a humidifier and exhaust vents, wherein said exhaust vents can mitigate prescreened hazardous conditions within the railcar with respect for the plurality of barrels.

The method may further comprise the steps of: providing ventilation slots in sidewalls of the railcar that are capable of adjustment or operation; and operating the ventilation slots to vent the flow of air within the railcar, to permit the flow of air throughout the railcar and over or across the barrels contained within the storage racks to achieve the desired levels of aeration, temperature, and humidity.

The method may further include the step of adding a set of spacers to separate the plurality of barrels from one another, and mitigating inertial interaction. The method may further comprise the step of connecting the railcar to a locomotive engine to impart movement to said railcar. The method may further comprise the step of connecting a plurality of railcars in a line connected to said locomotive engine.

These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1 is a front perspective view of a representative model of a series of barrel racks

FIG. 2 is a side perspective view of a representative model railcar storage facility for ageing alcohol spirits.

FIG. 3 is an above perspective view of a representative loaded model railcar storage facility for ageing alcohol spirits.

FIG. 4 is a rear perspective view of a representative model railcar storage facility for ageing alcohol spirits.

FIG. 5 is front perspective view of a representative model barrel exhibiting its dimensions.

FIG. 6 is a front perspective view of a representative model barrel storage rack showing dimensional measurements.

### DETAILED DESCRIPTION OF THE INVENTION

For purposes of promoting and understanding of the principles of the invention, reference will now be made to the embodiments illustrated in the drawings and specific language will be used to describe the same. It will nevertheless be understood that no limitation of the scope of the invention is thereby intended. The invention includes any alterations and further modifications in the illustrated devices and described methods and further applications of the principles of the invention that would normally occur to one skilled in the art to which the invention relates.

The inventor has conceived novel technology, that for illustrative purposes, is disclosed herein as applied in the context of alcohol spirit ageing process while capable and engaged in periodic transit by locomotion upon rail. While the disclosed applications of the inventor’s technology are intended to satiate an ever-present and elusive need within the field of art, alcohol spirit ageing processes, the interpretive limitations of the technology as disclosed are not warranted with regard for the precise manners of the invention as disclosed herein. Rather, the intention of the disclosure herein may give rise to additional implementations by other manners or means of ageing alcohol spirits in tandem with rail transit which without undue experimentation by those of ordinary skill in the art in light of this disclosure and therefore should not be limited to the examples detailed herein, but rather should be understood as merely illustrative.

Conventional alcohol spirit ageing processes, and their respective facilities are to some lesser degree adequate, clearly exhibiting potential for improvements in storage efficacy and efficiency through the maturation process by using storage facilities that can take advantage of available active and passive transit characteristics or conditions of an improved storage facility and storage locations. By way of introduction, maximization of the active and passive characteristics or conditions of transit may improve the flavor profile and efficiency for which the alcohol spirits are produced.

Actively available characteristics within rail transit, i.e. “active features,” can depend on the location of the rail line, including progressive elevations, temperature variation during the transit, velocity during transit as contributing to air flow, and reverberation leading to agitation within the contents of the barrels. Further, passively available characteristics within rail transit, i.e. “passive features, can depend on characteristics that may introduce desirable characteristics (e.g. humidity in the air flow present with the food products contained within barrels), temperature and air flow variations while not engaged in transit and any combinations thereof.

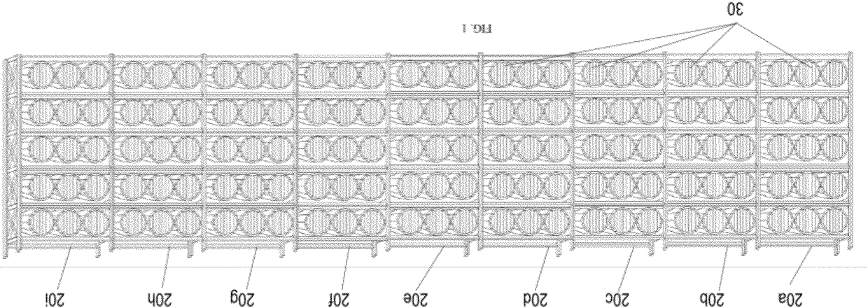

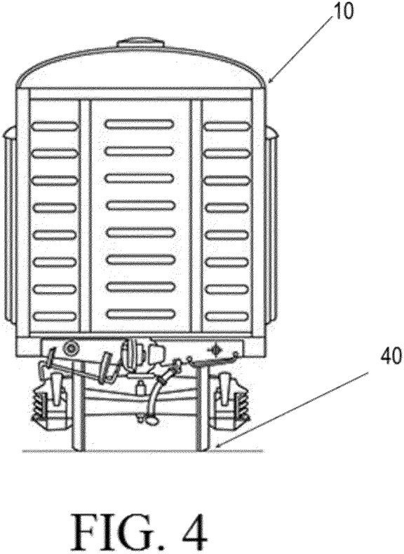

As best shown in FIG. 1 - FIG. 4, one presently preferred embodiment of the invention comprises a method for ageing alcohol spirits by way of rail transit in a box railcar 10, commonly referred to as a “boxcar”. While the examples described herein refer to the facility as a railcar, it shall be merely to illustrate, and further in no way limit the scope of the different spirit ageing facilities encompassed herein including other sorts of spirit ageing facilities capable of rail transportation, having distinct characteristics such as variable sizes, shapes, and functionality.

A railcar 10 or other spirit ageing facility may be placed upon a railroad and thereby take advantage of the active features aforementioned by engaging in transit, and the passive features aforementioned when not engaged in transit. Further, exemplary spirit aging facilities may have a variety of suitable proportions. Beneficial rail transit capable storage facilities range from approximately 50 feet in length to 150 feet in length, approximately 8 feet in width to 12 feet in width, and approximately 10 feet in height to 20.5 feet in height.

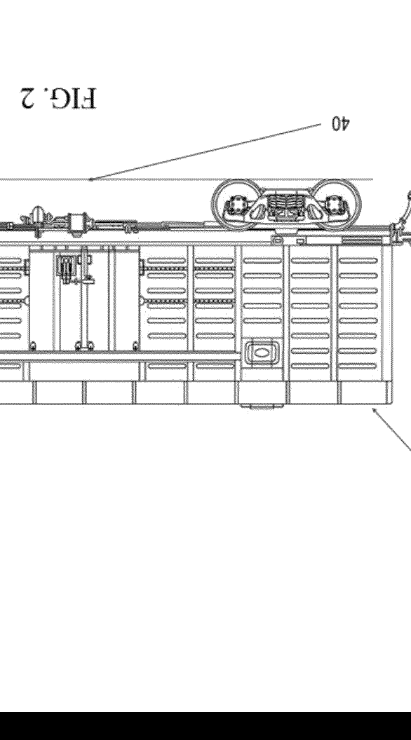

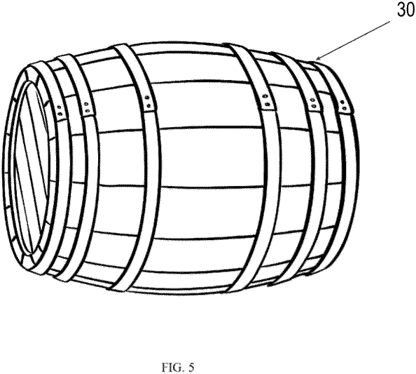

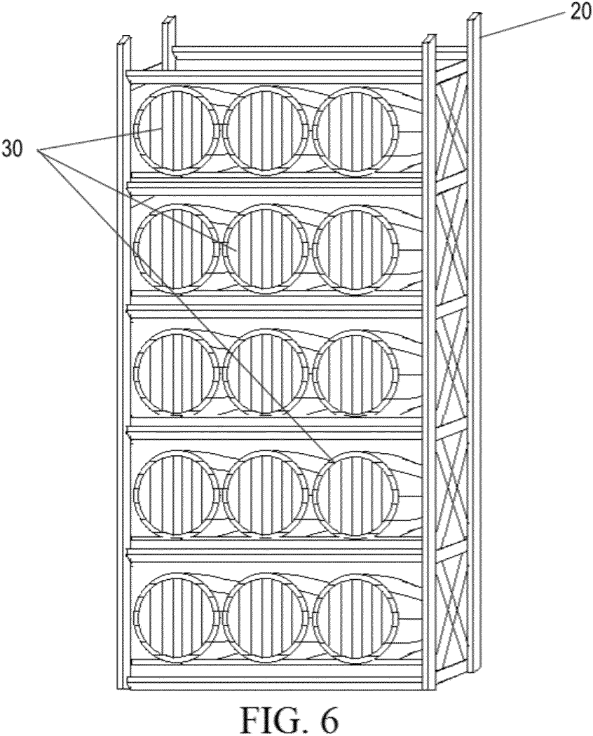

A railcar 10 such as that in FIG. 2 can be a railcar used for the transportation of other commodities upon railroads, or that has been built specifically for the ageing of spirits upon the railroad. For example, according to one aspect of the invention, an “autorack” rail car measures internally approximately 90 feet long, 9.1 feet wide and 13 feet tall. Such a rail car, when loaded with barrel storage racks 20 such as those indicated in FIG. 6, and in tandem throughout the car indicated by FIG. 1, can hold approximately 2000 whiskey barrels. However, as each 53-gallon barrel 30, indicated in FIG. 5 weighs approximately 550 pounds, the railcars will most likely “weigh out before cubing out”, with respect for the intended transit capabilities. Where the autorack would be capable of holding 2000 barrels based upon the cubic feet internal specifications, the autorack is only capable of transporting approximately 180,000 pounds, or roughly 327 full barrels containing alcohol spirits. Commonly this weight to space dynamic is referred to as “weighing out before cubing out”. As an exemplary contrast to the autorack, a boxcar, which is approximately 60 feet in length, 9.3 feet in width and 11 feet in height can hold approximately 1,025 barrels based upon the available cubic space within the boxcar, and can further hold up to 364 barrels based upon the standard weight specifications, when not accounting for additional weight constraints such as the racks for the barrels.

The dimensions and storage capabilities described herein are exemplary for each car in nature and should be understood that neither the type of railcar, nor combination of railcars into unit trains are intended to limit the scope of the invention. That is to say, the storage of spirits upon the rail offers additional benefits insofar as scalability, mobility and and increased volume of storage as railcars can be linked together to form entire unit trains which are capable of transit upon rail lines when then connected to one or more locomotives. Furthermore, facility construction and material certainly vary, but are typically constructed from durable materials that offer a heightened degree of thermal conductivity (e.g. steel, and/or fiberglass). Further the choice of spirit ageing facility capable of rail transit may depend on factors such as cost, capacity, scalability and access to additional railways.

With reference to FIG. 1 - FIG. 4 an additional exemplary spirit ageing facility is shown. The facility consists of a plurality of storage racks 20a, 20b, 20c ... placed on the interior of the railcar 10. The railcar 10 may be connected to other railcars of similar configurations, or even perhaps containing other cargo so as to form a unit train consisting of approximately 10 railcars up to 150 railcars. Therefore, the spirit ageing facility comprises of a series of internal spirit ageing storage racks 20 contained within a railcar 10 situated upon a railway 40, that may be scaled up to multiple similarly situated railcars, throughout a unit train, and attached to locomotive(s) for movement from place to place as desired. The exemplary ageing facility may be configured to store approximately between 270 (one rail car) up to 40,500 (150 rail cars comprising a unit train) 53-gallon barrels that may be attached to a locomotive or series of locomotives capable of periodic transit upon the railway.

With reference to FIG. 6, the height, width and depth of the barrel racks 20 may vary to better facilitate greater or lesser degrees of temperature variation, air flow, humidity and agitation within the interior of the railcar. Furthermore, particular types of materials may be used in the construction of the racks 20 with selection determined by a person of ordinary skill in the art with respect for the disclosures herein. The racks 20 may be constructed of woods, plastics, metals, or a combination thereof as appropriate for the structural integrity of the racks and purpose of ageing spirits while in transit. Barrel or spirit container construction will vary based on the type of alcohol spirit that is being aged, such as never before used white oak, charred on the inside for bourbon barrels, before the addition of the spirit thereto.

There exists a plethora of advantages to a railcar for ageing, and storing alcohol spirits. Beyond the obvious high storage capacity, that is capable of moving from place to place upon railroads, the rail cars allow for increased accessibility to the stored barrels, the loading and unloading of the barrels by machinery such as forklifts or cranes if desirable, and the increased organization efficiency of the varying aged spirits by car while combined into a unit train. Furthermore, the advantages of temperature, elevation, agitation and humidity variation while the barrel storage racks 20 reside in the rail car 10, up off the ground, and while capable of transit between places creates new flavor profiles previously unattainable in conventional ageing processes. Consider, that such a railcar 10 in transit during the day, while exposed to direct sunlight, will heat up as the sidewalls and roof of the rail car are made of steel and conduct significant amounts of heat into the interior storage areas. Whereupon during the summer months the temperatures may exceed 100° F., and thereby creating the possibility of convection heat transfer between the barrels 30 within the rail car 10.

Thereafter, and dissimilar to conventional rickhouse warehousing and barrel storage structures, the storage areas within a railcar 10 will have consistent cyclical appreciation and depreciation of temperature variation throughout the railcar 10 and would most likely yield a more fungible ageing process for the spirits contained therein. Particular to fungibility, as an advantage, the consistent movements of the railcar from location to location thereupon the railway during specific weather occurrences, notably certain temperatures and humidity ranges, during certain seasons, would stand to uniformly generate unique fungible flavor profiles within spirits aged therein to a greater degree than conventional methods of ageing.

An additional advantage to a railcar storage facility for ageing spirits is the natural agitation and reverberation of the movement of the car while engaged in transit. The railcar while situated upon a railroad and while attached to a locomotive is capable of transit from place to place. Upon such an occurrence, the ambient reverberation of the locomotion will allow for active oscillation and movement of the contents of barrels within the railcar throughout the journey. Agitation by reverberation is indicated by forces created by locomotion upon rail and translates into motion within the contents of the storage area such as the barrel racks 20, and the barrels 30 themselves. Moreover, as the motion and reverberation reach the barrels 30 and their respective contents it will cause the alcohol spirits to slosh and agitate within the barrel 30, which in turn permits the dispersion of the flavors and sugars more efficiently and effectively throughout the contents of the barrel 30, as compared to a conventional static state barrel storage facility during a comparable spirit ageing process.

Over the life of the spirits’ ageing process the increased exposure caused by the reverberation and agitation of locomotion will increase osmotic efficiency and efficacy of the spirits and their interaction with the internal walls of their containers and thereby have a direct effect upon the development of the spirits’ flavor profile as derived from the internal walls of the barrel it is contained within during the ageing process.

Further advantages to a railcar, or series of railcar spirit storage facilities exist because of the capacity to facilitate accelerated air flow while the rail car is in transit. That is, the rail car may permit a control for dampening or accelerating the natural air flow in and through the outer walls of the rail car containing barrels of spirits so as to increase the exposure of the outer walls of the barrels to the air flow available as the rail car travels upon the railroad if deisireable. Further, this increase of air flow during the periodic transportation over the spirit’s ageing process may permit new and unique flavor profiles depending on the dynamics of the immediate topographical features contributing to the air flowing through the railcar. In turn, the speed of the locomotion along with the railcar walls capability of facilitating and controlling air flow in certain circumstances which may be apparent to a person of ordinary skill, with respect for the air flow desired in light of the disclosures herein, may provide for ample and superior air flow dynamics in ageing spirits contained within barrels upon railcars during periodic transit that have a direct effect on desired flavor indicative features of the food products therein.

Another advantage to rail car spirit storage facilities exists as the ability to control the agitation levels. As aforementioned herein, while in transit the barrels stored in a railcar are subject to agitation because of the reverberation of locomotion while the rail car is engaged in periodic transit. A person of ordinary skill in the industry of ageing alcohol spirits in barrels may seek to control, or limit the agitation that the barrels incur while in transit by utilizing inertial dampeners, as may become apparent, which in effect would control the degree of agitation periodically during certain phases of transit, or perhaps certain phases of the ageing process. Particular to inertial dampeners, the ballast upon the railroad, undergirding the railway, may be augmented to dampen the “reverberative” effect so as to mitigate the agitation effect during the periodic transit aforementioned to a sweet spot of ideal agitation for the marketable food product. Alternatively, storage racks capable of facilitating shock absorption may be affixed below the storage racks so as to mitigate the “reverberative” effects of the periodic transit and manage the agitation levels of the spirits within the barrels.

Furthermore, a spirit ageing facility affixed within a railcar may have instruments installed upon it that are capable of gathering and relaying data related to the spirit ageing process and aiding in ensuring security within the railcar with respect to the contents. By example, a facility such as a railcar may have a thermometer for temperature, a hydrometer for humidity levels, a vane anemometer for measuring air flow rates and an accelerometer to measure the agitation levels with regard for the motion of transit. Furthermore, the data outputs rendered by the aforementioned or other unenumerated measurements could be manually taken or taken remotely by a computer relay system and thereby used on a rolling basis to adjust variables germane to the railcar ageing experience for the spirits and improve the quality control assurance of the ageing process of the spirits contained within the railcar(s).

Depending upon the variable conditions present in the exemplary storage facilities disclosed herein, spirits may be stored for a time period that is sufficient to ensure appropriate maturation of the relative spirit. That is, most spirits are aged between at least one-half year and up to 6 years, and in some instances, spirits are aged up to 10, 12, and even in excess of 20 years. The desirable characteristics evident in some spirits ageing facilities require longer ageing processes than others. The disclosures herein are intended to facilitate all permissible ageing durations, including those for the full life of the patent, and even in some instances longer.

An exemplary barrel is shown in FIG. 5 having a diameter of approximately 24 inches, a length of approximately 36 inches. Whereas, an exemplary barrel storage rack shown in FIG. 6 has configuration to hold 15 barrels, across three columns and 3 rows. The rack has a length of approximately 140 inches, by a width of approximately 78 inches, and a depth of approximately 38 inches, and is lifted approximately 3 inches from the surface of the floor. Such a rack can facilitate a row of three barrels, each being approximately 36 inches long, and being separated from one another by a space of one inch. Further the barrels can be positioned to maintain roughly 2 inches above and below the barrel. While positioned in this manner, a column of five barrels, by a row of three barrels consists of one “barrel rack”, and can facilitate the storage of approximately 8,250 pounds with a full barrel rack.

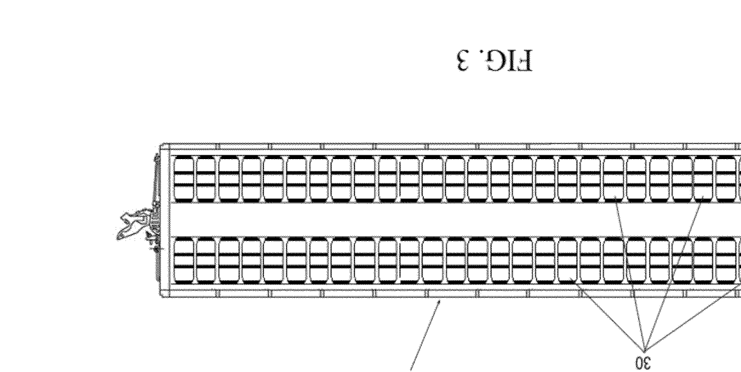

Some exemplary spirit ageing facilities may allow for a series of racks 20, consisting of more than one rack of nine barrels 30, that are adjoined or affixed together by the use of a bracket, that span the gap between the racks. By example, FIG. 1 shows a series of 9 racks abutting one another which are joined together by an array of brackets or other conjoining apparatuses such that each structure may hold up to 135 53-gallon barrels. Additional racks may be implemented along the other racks so as to form a series of racks or a block of racks as desired by a person of ordinary skill within the art. Blocks of racks may be placed in the railcars as shown in FIG. 3, in addition to, or instead of individual racks.

Referring now to FIG. 3 and FIG. 4, those figures show a rail car 10 having an overall length of approximately 68 feet and an interior length of approximately 61 feet. The rail car in FIG. 3 and FIG. 4 has an overall width of approximately 10.6 feet and an interior width of approximately 9.5 feet. In this barrel storage configuration, as best shown in FIG. 3, two rows can run the length of the railcar 10, with each row having a total width of approximately 58.5 feet, and a height of approximately 12 feet, facilitating approximately 270 barrels within each railcar, weighing approximately 148,500 pounds. Within an entire unit train, consisting of up to 105 railcars, a total capacity per unit train would be approximately 28,350 53-gallon barrels. Configurations may remove one or more racks within the barrel racks so as to facilitate additional loading areas where heavy equipment may be utilized to load or unload, or to permit additional objects into the railcars.

Some configurations of the barrel racks may increase or decrease the number of barrel racks within the railcars, thereby increasing or decreasing the total number of overall barrels that could be aged in accordance with this process. For example, in some configurations the barrel racks may be reconfigured to run horizontally, rather than vertically with the rail car, due to the availability of loading equipment or other methods of moving the rail cars depending on the totality of the unit train the rail car is a part of, particularly with larger unit trains consisting of greater than 2,500 barrels.

While the examples of FIG. 1 - FIG. 4 show one possible configuration of the disclosed method and technology for storing barrels 30 containing aqueous alcohol spirits for ageing, it should be understood that other barrel sizes, rack dimensions, and railcar sizes and layouts exist when utilizing the techniques described herein, and such variations shall be apparent to one of ordinary skill in the art in light of the disclosure herein. Moreover, as this disclosure is illustrative rather than exhaustive, the intended purpose of the disclosure is to include all possible permutations of spirits ageing within barrels, affixed upon racks, contained within rail cars capable of periodic transit.

While the descriptions of the method herein have focused on characteristics and advantages of spirit ageing facilities that is within railcars and capable of transit by way of locomotion from place to place, it should be understood that the descriptions herein apply generally to any facility which is designed to take advantage of the active or passive characteristics of railroads, and locomotion in order to create advantageous conditions for spirit ageing factors such as temperature, elevation, humidity, air flow, agitation, during the ageing process of spirits.

Variation of features, and applications of the inventor’s technology and methodology will be apparent to, and may be practicable for those of ordinary skill in the art, in light of this disclosure without undue experimentation. The protections accorded by this document or by any related documents shall not be limiting to the material explicitly disclosed herein.

The following examples relate to the various non-exclusive ways in which the concepts and methodology herein may be applied. It shall be understood that the following examples are intended to merely illustrate possible ways the method of ageing may be combined, rather than a restrictive coverage of the claims contained herein. Zero disclaimers are intended or offered. With prospective contemplation, various arrangements and even features may be applied or configured in other ways. Therefore, none of the references below should be deemed critical unless explicitly indicated as such at a later date by the inventors or successors in interest to the inventors. Should any claim in this application or subsequent filings related to this application include additional features beyond those referred to hereafter, those features shall not be presumed to have been added for any reason in furtherance of patentability.

### EXAMPLES

### Example 1

A storage facility consisting of a floor, a ceiling, and walls, wherein the aforementioned may be permeable to airflow and thermally conductive, wherein the storage facility having an interior area containing racks of barreled alcohol spirits and those racks of barrels is subject to temperature variation as the solar energy from the sun rises and falls throughout the day, and wherein the storage area is designed to facilitate the temperature variation and air flow fluctuation within.

### Example 2

The storage facility of any other example, wherein the storage facility is placed upon a railcar, set upon a railroad, wherein the railcar is capable of transit, subject to locomotion, from place to place from time to time.

### Example 3

The storage facility of any other example, wherein the storage facility is a functioning railcar.

### Example 4

The storage facility of any other example, wherein the storage facility is place upon a railcar, affixed upon a railroad, wherein the railcar is connected to a locomotive that may cause the storage facility to move by way of locomotion across the rail, from place to place, subjecting the content of the storage facility to air flow externally in transit and agitation, sloshing, or churning internally.

### Example 5

The storage facility of any other example, wherein the storage facility is between approximately 50 feet and 100 feet long, between approximately 8 feet to 15 feet wide, and between approximately 10 feet to 25 feet high.

### Example 6

The storage facility of any other example, further consisting of an array of instruments capable of indicating temperature, air flow, humidity, and other measurable data sets relevant to ageing spirits, wherein the array is configured to indicate characteristics of the interior storage facility area.

This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

I claim:

1. A system for ageing aqueous spirits comprising:
a. a railcar positioned on railroad tracks;
b. a plurality of storage racks positioned in an interior area of the railcar;
c. a plurality of barrels removably positioned on said storage racks, each of said plurality of barrels containing aqueous spirits;
d. means for moving said railcar on said railroad tracks thereby agitating the aqueous spirits in the barrel to maximize the spirits flavor profiles with regard for temperature, humidity, elevation and aeration.

2. The system of claim 1, wherein the plurality of barrels are wooden barrels.

3. The system of claim 1, further comprising:
a. a set of instruments positioned upon and within the railcar for collecting data during the ageing period; and
b. means for correlating a dataset of information collected by said set of instruments with the plurality of barrels, wherein the dataset comprises a set of temperature, humidity, airflow, elevation, pressurization or depressurization and vibration measurements.

4. The system of claim 3, further comprising a set of climate control devices to achieve a desired temperature, humidity, aeration, and agitation levels based upon the dataset produced by the set of instruments within the interior storage area.

5. The system of claim 4, wherein the set of devices comprises a humidifier and a plurality of exhaust vents, wherein said exhaust vents can mitigate prescreened hazardous conditions within the railcar with respect for the plurality of barrels.

6. The system of claim 1, further comprising ventilation slots located in sidewalls of the railcar, said ventilation slots being capable of adjustment or operation.

7. The system of claim 1, further comprising a set of spacers for separating the plurality of barrels from one another.

8. The system of claim 1, wherein said means for moving said railcar comprises means for selectively and repeatably moving the railcar as desired and necessary to maximize the spirits flavor profiles with regard for temperature, humidity, elevation, aeration.

9. The system of claim 1, wherein said means for moving comprises a locomotive engine connected to said railcar.

10. The system of claim 9, wherein a plurality of railcars, each containing a plurality of racks and a plurality of barrels, are connected in a line to said locomotive engine.

11. A method for ageing aqueous spirits comprising the steps of:
a. positioning a railcar on railroad tracks, said railcar having a plurality of storage racks positioned in an interior area thereof;
b. positioning a plurality of barrels containing aqueous spirits on said storage racks;
c. ageing the aqueous spirits in the plurality of barrels for a period of time;
d. removing the barrels of aged aqueous spirits from the storage racks and from the interior area of the railcar.

12. The method of claim 11, further comprising the step of periodically moving said railcar on said railroad tracks during said ageing step thereby agitating the aqueous spirits in the barrel to maximize the spirits flavor profiles with regard for temperature, humidity, elevation and aeration.

13. The method of claim 11, wherein the plurality of barrels are wooden barrels.

14. The method of claim 11, further comprising the steps of:
a. collecting from a set of instruments positioned upon and within the railcar during the ageing period; and
b. correlating a dataset of information collected by said set of instruments with the plurality of barrels, wherein the dataset comprises a set of temperature, humidity, airflow, elevation, pressurization or depressurization and vibration measurements.

15. The method of claim 13, further comprising the step of operating a set of climate control devices to achieve a desired temperature, humidity, aeration, and agitation levels based upon the dataset produced by the set of instruments within the interior storage area.

16. The method of claim 15, wherein the set of devices comprises a humidifier and exhaust vents, wherein said exhaust vents can mitigate prescreened hazardous conditions within the railcar with respect for the plurality of barrels.

17. The method of claim 11, further comprising the steps of:
a. providing ventilation slots in sidewalls of the railcar that are capable of adjustment or operation; and
b. operating the ventilation slots to vent the flow of air within the railcar, to permit the flow of air throughout the railcar and over or across the barrels contained within the storage racks to achieve the desired levels of aeration, temperature, and humidity.

18. The method of claim 11, further comprising the step of adding a set of spacers to separate the plurality of barrels from one another, and mitigating inertial interaction.

19. The method of claim 11, further comprising the step of connecting the railcar to a locomotive engine to impart movement to said railcar.

20. The method of claim 19, further comprising the step of connecting a plurality of railcars in a line connected to said locomotive engine.
